(19) United States
(12) Patent Application Publication
(10) Pub. No.: US 2012/0313912 A1
(43) Pub. Date: Dec. 13, 2012

(54) DISPLAY DEVICE WITH LIGHT SENSOR

(75) Inventors: Yuuichi Kanbayashi, Osaka (JP); Hiromi Katoh, Osaka (JP)

(73) Assignee: SHARP KABUSHIKI KAISHA, Osaka (JP)

(21) Appl. No.: 13/581,205

(22) PCT Filed: Oct. 14, 2010
(86) PCT No.: PCT/JP2010/068020

§ 371 Date: Aug. 24, 2012

(30) Foreign Application Priority Data
Feb. 26, 2010 (JP) 2010-042253

(51) Int. Cl. G09G 5/00

(52) U.S. Cl. 345/207

(57) ABSTRACT

Disclosed is a liquid crystal display device including a liquid crystal panel 20 equipped with a plurality of light sensors, a white backlight 31, and an infrared backlight 32. The infrared backlight 32 is turned ON and OFF at a prescribed timing. Some of the light sensors detect light when the infrared backlight 32 is ON, and other light sensors detect light when the infrared backlight 32 is OFF. The white backlight 31 turns OFF for light sensors conducting the light detection. Thus, the effective range of the light sensors included in the display device can be widened.

### TECHNICAL FIELD

The present invention relates to a display device, and particularly to a display device equipped with a plurality of light sensors included in a display panel.

### BACKGROUND ART

In recent years, electronic devices that can be operated by touching the screen with a finger, a pen, and the like are in wide use. It is known that the location of a touch on a display panel can be detected by processing the inputted images obtained from a plurality of light sensors disposed on the display panel. Such a display device equipped with light sensors is required to detect the touch location accurately, without being influenced by the presence of external light.

A variety of methods have already been devised to increase the accuracy with which the touch location is detected. For example, a method in which a backlight that emits infrared light is used is disclosed in Patent Document 1, and a method in which a filter is disposed in the path of the light entering the light sensor to transmit infrared light but to block visible light is disclosed in Patent Document 2. In Patent Document 3, a method in which a black image is displayed at a certain timing, and an image having a luminance higher than that of the black image (a blue image, for example) is displayed at a different timing is disclosed. Further, in Patent Document 4, a method in which two light-emitting means, a first light-emitting means that emits invisible light and a second light-emitting means emitting visible light, are controlled in a parallel manner is disclosed.

### RELATED ART DOCUMENTS

### Patent Documents

Patent Document 1: WO 2009/110294
Patent Document 2: WO 2009/110293
Patent Document 3: Japanese Patent Application Laid-Open Publication No. 2008-286914
Patent Document 4: Japanese Patent Application Laid-Open Publication No. 2009-157605

### SUMMARY OF THE INVENTION

### Problems to be Solved by Invention

Generally, in a display device including a backlight, the light emitted from the backlight (backlight light) is reflected inside the display panel. The backlight light is reflected by the pixel electrode, the polarizing plate, and the protecting plate, for example. Consequently, in a display device equipped with light sensors, an infrared backlight, and a visible light shielding filter, a portion of the backlight light (visible light) for display enters the light sensors as a noise. This can create a problem of reduced effective range (the range of light amount that can be used) of the light sensor necessary for detection of touch locations.

This problem becomes significant when the light sensor is made of amorphous silicon. FIG. 21 shows the spectral sensitivity characteristics of light sensors made of polysilicon, microcrystalline silicon, or amorphous silicon. As shown in FIG. 21, the ratio of the sensitivity at the wavelength of 850 nm and the sensitivity at the wavelength of 550 nm is about 1:100 in the case of the light sensor made of polysilicon, and about 1:10000 in the case of the light sensor made of amorphous silicon. That is, if a polysilicon light sensor and an amorphous silicon light sensor are formed to have an equal sensitivity to infrared light, the sensitivity to white light of the amorphous silicon light sensor will be about 100 times higher than that of the polysilicon light sensor. Therefore, in the case of the light sensor made of amorphous silicon, if white backlight light is reflected within the display panel and enters the light sensor by even a very small amount, the output of the light sensor becomes saturated. For this reason, when infrared light is used for detecting touch locations, it is extremely difficult to use light sensors made of amorphous silicon.

With conventional display devices with light sensors that are disclosed in Patent Documents 1 to 4, the problem that the backlight light is reflected inside the display panel and enters the light sensor, reducing the effective range of the light sensor, cannot be solved.

Therefore, the present invention aims at providing a display device equipped with light sensors having a wide light sensor effective region.

### Means for Solving the Problems

A first aspect of the present invention is a display device equipped with a plurality of light sensors, including:

a display panel having a plurality of light sensors arranged thereon in a two dimensional manner;

a first light source that emits visible light;

a second light source that emits infrared light; and

a filter disposed in a path of light entering the light sensors to transmit infrared light and blocks visible light,

wherein the first light source is turned OFF for light sensors conducting light detection.

A second aspect of the present invention is the first aspect of the present invention,

wherein the light sensors include light sensors that detect light during a first detection period, and light sensors that detect light during a second detection period,

wherein the first light source is turned OFF during the first and second detection periods for a region that includes the light sensors conducting the light detection, and

wherein the second light source is turned ON during the first detection period for the region that includes the light sensors conducting the light detection, and is fully turned OFF during the second detection period.

A third aspect of the present invention is the second aspect of the present invention, wherein each frame period includes one first detection period and one second detection period, which are set to have the same duration.

A fourth aspect of the present invention is the second aspect of the present invention, wherein the first light source is fully turned OFF during the first and second detection periods.

A fifth aspect of the present invention is the second aspect of the present invention, wherein the second light source is fully turned ON during the first detection period.

A sixth aspect of the present invention is the second aspect of the present invention, wherein the first light source is partially turned OFF during the first and second detection periods for a detection region set on a display screen.

A seventh aspect of the present invention is the second aspect of the present invention, wherein the second light source is partially turned ON during the first detection period for the detection region set on the display screen.

An eighth aspect of the present invention is the sixth or the seventh aspect of the present invention, wherein the detection region has a size in accordance with the detection object.

A ninth aspect of the present invention is the sixth or seventh aspect of the present invention, wherein the detection region is set when a detection object approaches the display panel.

A tenth aspect of the present invention is the first aspect of the present invention,

wherein the first light source is partially turned OFF for a band-shaped region moving in a display screen in a prescribed direction, and

wherein light sensors corresponding to the band-shaped region conduct light detection.

An eleventh aspect of the present invention is the tenth aspect of the present invention, wherein the second light source is fully turned ON.

A twelfth aspect of the present invention is the tenth aspect of the present invention, wherein the second light source is partially turned ON for the band-shaped region.

A thirteenth aspect of the present invention is the first aspect of the present invention, wherein the light sensors are made of amorphous silicon.

A fourteenth aspect of the present invention is the first aspect of the present invention, wherein the light sensors are made of microcrystalline silicon.

A fifteenth aspect of the present invention is the first aspect of the present invention, wherein the light sensors are made of polysilicon.

### Effects of the Invention

According to the first aspect of the present invention, because the first light source is turned OFF for the light sensors conducting the light detection, visible light emitted from the first light source can be prevented from entering the light sensors conducting the light detection, and the effective range of the light sensors can be widened.

According to the second aspect of the present invention, because the light amount when the second light source is ON and the light amount when the second light source is OFF are detected and the difference between the two is determined, an inputted image free of external light influence can be obtained. Also, because the first light source is turned OFF during the first and second detection periods for a region that includes the light sensors conducting the light detection, visible light emitted from the first light source can be prevented from entering the light sensors conducting the light detection, and the effective range of the light sensors can be widened.

According to the third aspect of the present invention, because each frame period includes one first detection period and one second detection period, which are set to have the same duration, an inputted image free of external light influence can be obtained in each frame.

According to the fourth aspect of the present invention, the first light source can easily be configured.

According to the fifth aspect of the present invention, the second light source can easily be configured.

According to the sixth aspect of the present invention, because the first light source is partially turned OFF for the detection region and the first light source can be left turned ON for other region that is not the detection region, any influence on the display can be reduced.

According to the seventh aspect of the present invention, because the second light source is partially turned ON for the detection region, the power consumption of the second light source can be reduced.

According to the eighth aspect of the present invention, because the size of the detection region is switched depending on the detection object, the influence on the display and the power consumption of the second light source can be reduced suitably for the detection object.

According to the ninth aspect of the present invention, because the detection region is set when a detection object approaches the display panel, the influence on the display and the power consumption of the second light source can be reduced in accordance with the distance between the detection object and the display panel.

According to the tenth aspect of the present invention, because the first light source is turned OFF for the band-shaped region and the light sensor corresponding to the band-shaped region detects the light, the visible light emitted from the first light source can be prevented from entering the light sensors conducting the light detection and the effective range of the light sensors can be widened.

According to the eleventh aspect of the present invention, the second light source can easily be configured.

According to the twelfth aspect of the present invention, because the second power source is partially turned OFF for the band-shaped region, the power consumption of the second light source can be reduced.

According to the thirteenth aspect of the present invention, because the light sensors are made of amorphous silicon, the light sensor sensitivity can be increased for applications requiring a high sensitivity.

According to the fourteenth aspect of the present invention, because the light sensors are made of microcrystalline silicon, a light sensor having a relatively high sensitivity and a relatively wide linear range can be provided for various applications.

According to the fifteenth aspect of the present invention, because the light sensors are made of polysilicon, the linear range of the light sensors can be widened for applications requiring a wide effective range.

### BRIEF DESCRIPTION OF THE DRAWINGS

FIG. 1 is a block diagram showing the configuration of a liquid crystal display device of Embodiment 1 of the present invention.

FIG. 2 is a cross-sectional view of a liquid crystal panel included in the liquid crystal panel shown in FIG. 1.

FIG. 3 shows the arrangement of sensor pixel circuits of the liquid crystal display device shown in FIG. 1.

FIG. 4 illustrates the timings at which processes are performed in the liquid crystal display device shown in FIG. 1.

FIG. 5 shows circuit diagrams of sensor pixel circuits of the liquid crystal display device shown in FIG. 1.

FIG. 6 shows the signal waveforms of the liquid crystal panel of the liquid crystal display device shown in FIG. 1.

FIG. 7 shows the operations of the sensor pixel circuit of the liquid crystal display device shown in FIG. 1.

FIG. 8 shows waveforms of signals of a sensor pixel circuit of liquid crystal display device shown in FIG. 1.

FIG. 9A shows a configuration example of the backlight of the liquid crystal display device shown in FIG. 1.

FIG. 9B shows another configuration example of the backlight of the liquid crystal shown in FIG. 1.

FIG. 9C shows yet another configuration example of the backlight of the liquid crystal display device shown in FIG. 1.

FIG. 9D shows yet another configuration example of the backlight of the liquid crystal display device shown in FIG. 1.

FIG. 9E shows yet another configuration example of the backlight of the liquid crystal display device shown in FIG. 1.

FIG. 9F shows yet another configuration example of the backlight of the liquid crystal display device shown in FIG. 1.

FIG. 9G is a cross-sectional view of the backlight shown in FIG. 9F.

FIG. 10 is an effective range of light sensors made of different materials.

FIG. 11A is a perspective view of a backlight having a tandem structure.

FIG. 11B is a cross-sectional view of a backlight having a tandem structure.

FIG. 11C shows a tandem type light guide plate.

FIG. 12 is a display screen example of a liquid crystal display device of Embodiment 2 of the present invention.

FIG. 13 is an application example of the liquid crystal display device of Embodiment 2.

FIG. 14 is another application example of the liquid crystal display device of Embodiment 2.

FIG. 15 is yet another application example of the liquid crystal display device of Embodiment 2.

FIG. 16 shows the arrangement of sensor pixel circuits of a liquid crystal display device of Embodiment 3 of the present invention.

FIG. 17 shows the timings at which processes are performed in the liquid crystal display device of Embodiment 3.

FIG. 18 shows the light detection region of the liquid crystal display device of Embodiment 3.

FIG. 19 is a circuit diagram of the sensor pixel circuit of the liquid crystal display device of Embodiment 3.

FIG. 20 shows the spectral characteristics of BR filter and RGB filter.

FIG. 21 shows the spectral sensitivity characteristics of liquid crystal panels made of different materials.

### DETAILED DESCRIPTION OF EMBODIMENTS

### Embodiment 1

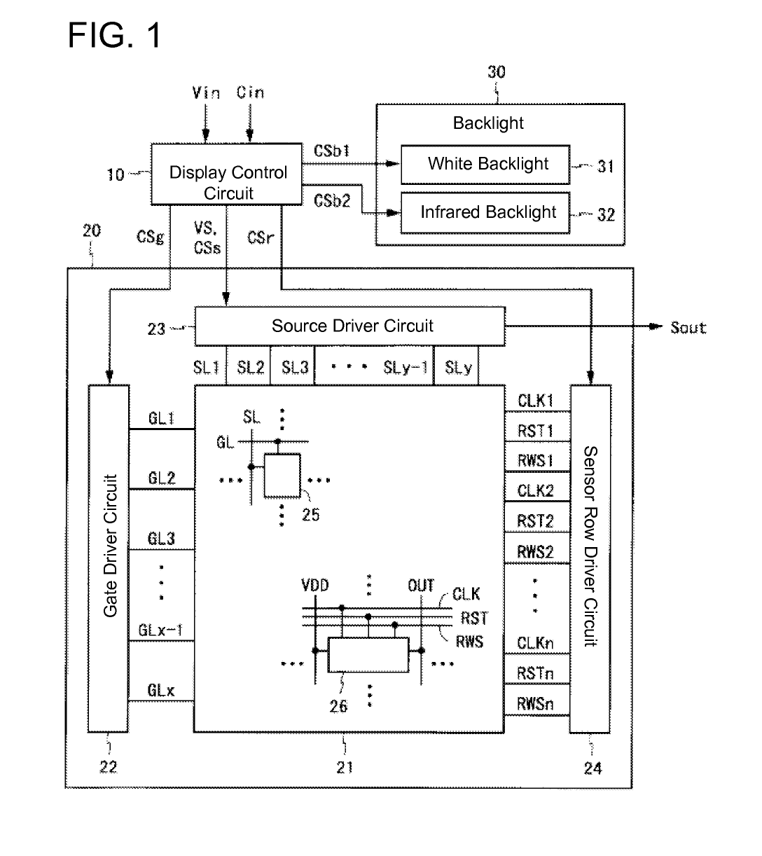

FIG. 1 is a block diagram showing the configuration of a liquid crystal display device of Embodiment 1 of the present invention. The liquid crystal display device shown in FIG. 1 includes a display control circuit 10, a liquid crystal panel 20, and a backlight 30. The liquid crystal display device has a function of displaying images on the liquid crystal panel 20, and a function of detecting the light entering the liquid crystal panel 20. Hereinafter, x and y are integers of at least 2, m and n are even numbers, and the frame rate of the liquid crystal display device is 60 frames/sec. Also, for an easy identification, signals are referred by the names of the signal lines carrying the signals (for example, the signal carried by the clock line CLK is referred to as clock signal CLK).

The liquid crystal display device shown in FIG. 1 receives an image signal Vin and a timing control signal Cin from outside. Based on these signals, the display control circuit 10 outputs an image signal VS and control signals CSg, CSs, and CSr to the liquid crystal panel 20, and outputs control signals CSb1 and CSb2 to the backlight 30. An image signal VS may be the same as the image signal Vin, or may be the image signal Vin that has been subjected to a signal processing.

The backlight 30 is provided on the back side of the liquid crystal panel 20 to emit light to the back side of the liquid crystal panel 20. The backlight 30 includes a white backlight 31 that emits white light (visible light) for display and an infrared backlight 32 that emits infrared light for light detection. The white backlight 31 functions as a first light source and the infrared backlight 32 functions as a second light source. The white backlight 31 is turned ON when the control signal CSb1 is at a high level, and the infrared backlight 32 is turned ON when the control signal CSb2 is at a high level.

The liquid crystal panel 20 includes a pixel region 21, a gate driver circuit 22, a source driver circuit 23, and a sensor row driver circuit 24. The pixel region 21 includes x gate lines GL1 to GLx, y source lines SL1 to SLy, (x x y) display pixel circuits 25, and (n×m/2) sensor pixel circuits 26. The gate lines GL1 to GLx are disposed in parallel to each other, and the source lines SL1 to SLy are disposed in parallel to each other such that they cross the gate lines GL1 to GLx at a right angle. (x x y) display pixel circuits 25 are disposed near the intersections of the gate lines GL1 to GLx and the source lines SL1 to SLy.

In the pixel region 21, n clock lines CLK1 to CLKn, n reset lines RST1 to RSTn, and n read-out lines RWS1 to RWSn are disposed in parallel to the gate lines GL1 to GLx. When signals are read out from the sensor pixel circuit 26, m source lines selected from source lines SL1 to SLy are used as power supply lines VDD1 to VDDm, and another m source lines are used as output lines OUT1 to OUTm.

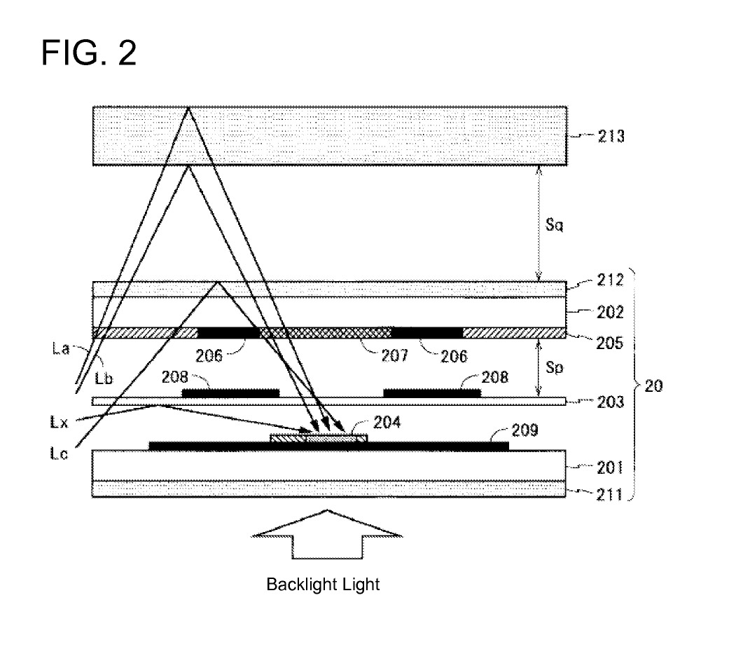

FIG. 2 is a cross-sectional view of the liquid crystal panel 20. As shown in FIG. 2, the liquid crystal panel 20 is configured such that liquid crystal substance (not shown) is sandwiched between two glass substrates 201 and 202 (Sp in FIG. 2). The glass substrate 201 on the back side has a pixel electrode 203, a light sensor 204, and the like formed thereon, and the glass substrate 202 on the display side has an opposite electrode (not shown), a color filter 205 for display, black matrices 206, a visible light shielding filter 207, and the like formed thereon. The visible light shielding filter 207 has characteristics of transmitting infrared light and blocking visible light, and is disposed to cover the light sensor 204. The visible light shielding filter 207 is formed by, for example, forming a red color filter and a blue color filter for display at the same location.

In order to prevent unnecessary light from entering the light sensor 204, light-shielding layers 208 are provided on the pixel electrode 203, and the light sensor 204 is disposed on the light-shielding layer 209 provided on the glass substrate 201. On the surfaces of the glass substrates 201 and 202 that are not facing each other, polarizing plates 211 and 212 are provided, respectively. On the display surface of the liquid crystal panel 20, a protective plate 213 is provided. The space between the glass substrate 202 and the protective plate 213 (Sq in FIG. 2) is filled with air.

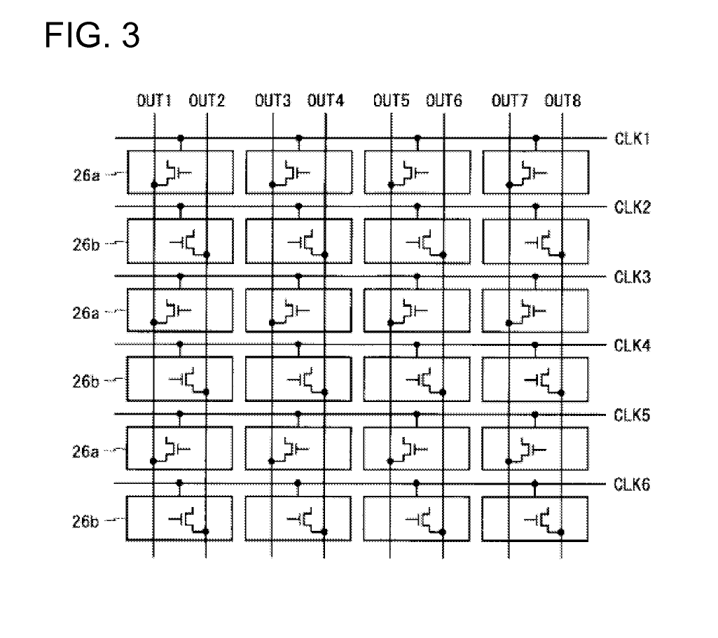

FIG. 3 shows the arrangement of sensor pixel circuits 26 in a pixel region 21. (n×m/2) sensor pixel circuits 26 include first sensor pixel circuits 26a that detect light when the infrared backlight 32 is ON and second sensor pixel circuits 26b that detect light when the infrared backlight 32 is OFF. There are the same number of the first sensor pixel circuits 26a and the second sensor pixel circuits 26b. As shown in FIG. 3, (n×m/4) first sensor pixel circuits 26a are disposed near the corresponding intersections of odd-numbered clock lines CLK1 to CLKn−1 and odd-numbered output lines OUT1 to OUTm−1. (n×m/4) second sensor pixel circuits 26b are disposed near the corresponding intersections of even-numbered clock lines CLK2 to CLKn and even-numbered output lines OUT2 to OUTm.

The gate driver circuit 22 sequentially selects one gate line from the gate lines GL1 to GLx based on the control signal CSg, and applies a high level potential to the selected gate line. As a result, y display pixel circuits 25 connected to the selected gate lines are collectively selected. The source driver circuit 23 applies a potential representing the image signal VS to the source lines SL1 to SLy based on the control signal CSs. The potentials applied to the source lines SL1 to SLy are written in to y display pixel circuits 25 selected by the gate driver circuit 22. Thus, by writing in potentials representing the image signal VS to all the display pixel circuits 25, a desired image can be displayed on the liquid crystal panel 20.

The sensor row driver circuit 24 applies a high level potential and a low level potential to the clock lines CLK1 to CLKn based on the control signal CSr (details are discussed below). Also, the sensor row driver circuit 24 applies at different timings a high level potential for resetting to odd-numbered reset lines RST1 to RSTn−1 and to even-numbered reset lines RST2 to RSTn based on the control signal CSr. As a result, the first sensor pixel circuits 26a are collectively reset at a certain timing, and the second sensor pixel circuits 26b are collectively reset at a different timing.

The sensor row driver circuit 24 sequentially selects two adjacent read-out lines out of the read-out lines RWS1 to RWSn based on the control signal CSr, and applies a high level potential for reading out to the selected read-out lines. As a result, m sensor pixel circuits 26 connected to the selected two read-out lines collectively enter a read-out enabled state. At this time, the source driver circuit 23 applies a high level potential to power supply lines VDD1 to VDDm. As a result, signals representing the light amount detected by individual sensor pixel circuits 26 (hereinafter referred to as “sensor signal”) are outputted from m sensor pixel circuits 26 in the read-out enabled state to output lines OUT1 to OUTm.

The source driver circuit 23 includes a differential circuit (not shown) that determines the difference between the output signal of the first sensor pixel circuit 26a and the output signal of the second sensor pixel circuit 26b. The source driver circuit 23 amplifies the differential light amount obtained by the differential circuit, and outputs the amplified signal outside the liquid crystal panel 20 as the sensor output Sout. Thus, by reading out the sensor signals from all the sensor pixel circuits 26, the light that has entered the liquid crystal panel 20 can be detected.

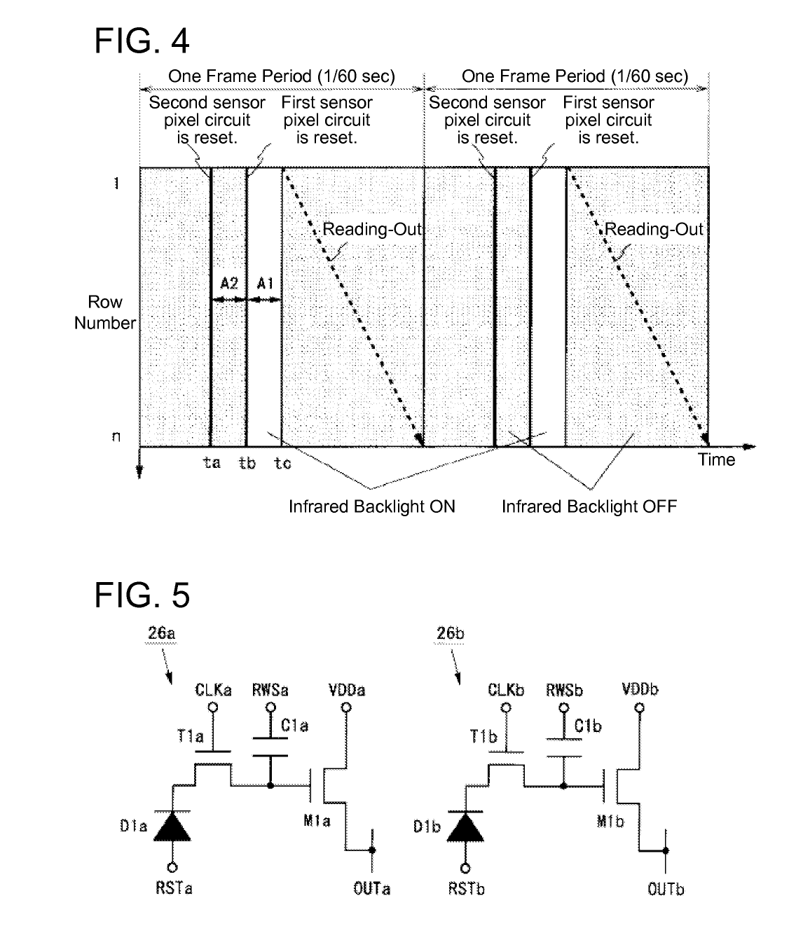

FIG. 4 illustrates the timings at which the infrared backlight 32 is turned ON and OFF and the sensor pixel circuits 26 are reset and read out. As shown in FIG. 4, the infrared backlight 32 is turned ON once during each frame for a prescribed time period, and is turned OFF during the rest of the time. Specifically, the infrared backlight 32 is turned ON in each frame period at a time tb, and is turned OFF at time tc.

At time tb, all the first sensor pixel circuits 26a are reset, and the first sensor pixel circuits 26a detect any incoming light during a period A1, which is from time tb to time tc (while the infrared backlight 32 stays ON). Also, at time ta, all the second sensor pixel circuits 26b are reset, and the second sensor pixel circuits 26b detect any incoming light during a period A2, which is from time ta to time tb (while the infrared backlight 32 stays OFF). The period A1 and the period A2 have the same duration. Reading out from the first sensor pixel circuits 26a and reading out from the second sensor pixel circuits 26b are performed in the order of the lines in a parallel manner after time tc.

The white backlight 31 is turned OFF during the light detection period A1 of the first sensor pixel circuit 26a and during the light detection period A2 of the second sensor pixel circuit 26b, and is turned ON at other times. Specifically, the white backlight 31 is turned OFF at time ta in each frame, and is turned ON at time tc.

FIG. 5 is a circuit diagram of the sensor pixel circuit 26. As shown in FIG. 5, in the first sensor pixel circuit 26a, the anode of the photodiode D1a is connected to the reset line RSTa, and the cathode is connected to the source of the transistor T1a. The gate of the transistor T1a is connected to the clock line CLKa, and the drain is connected to the gate of the transistor M1a. The drain of the transistor M1a is connected to the power supply line VDDa, and the source is connected to the output line OUTa. A capacitor C1a is disposed between the gate of the transistor M1a and the read-out line RWSa. In the first sensor pixel circuit 26a, the node connected to the gate of the transistor M1a is a building-up node that builds up a charge representing the detected light amount. The photodiode D1a functions as the light sensor 204 shown in FIG. 2. The second sensor pixel circuit 26b has the same configuration as the first sensor pixel circuit 26a.

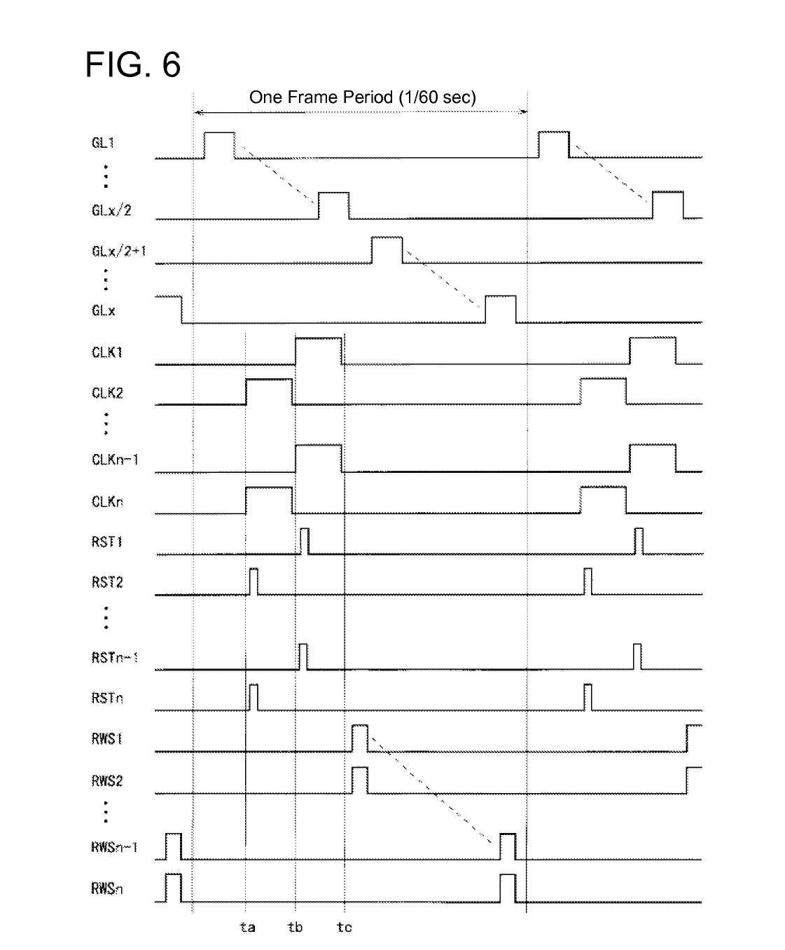

FIG. 6 shows the signal waveforms of the liquid crystal panel 20. As shown in FIG. 6, the potentials at gate lines GL1 to GLx sequentially become a high level once in each frame period for a prescribed time. The odd-numbered clock signals CLK1 to CLKn−1 become a high level once in each frame period, in period A1 (more specifically, from time tb to immediately before time tc). The even-numbered clock signals CLK2 to CLKn become a high level once in each frame period, in period A2 (more specifically, from time ta to immediately before time tb). The odd-numbered reset signals RST1 to RSTn−1 become a high level once in each frame period, for a prescribed time at the beginning of period A1. The even-numbered reset signals RST2 to RSTn become a high level once during each frame period, for a prescribed time at the beginning of period A2. Two of the read-out lines RWS1 to RWSn are paired, and (n/2) read-out signals become a high level sequentially, each for a prescribed time, after time tc.

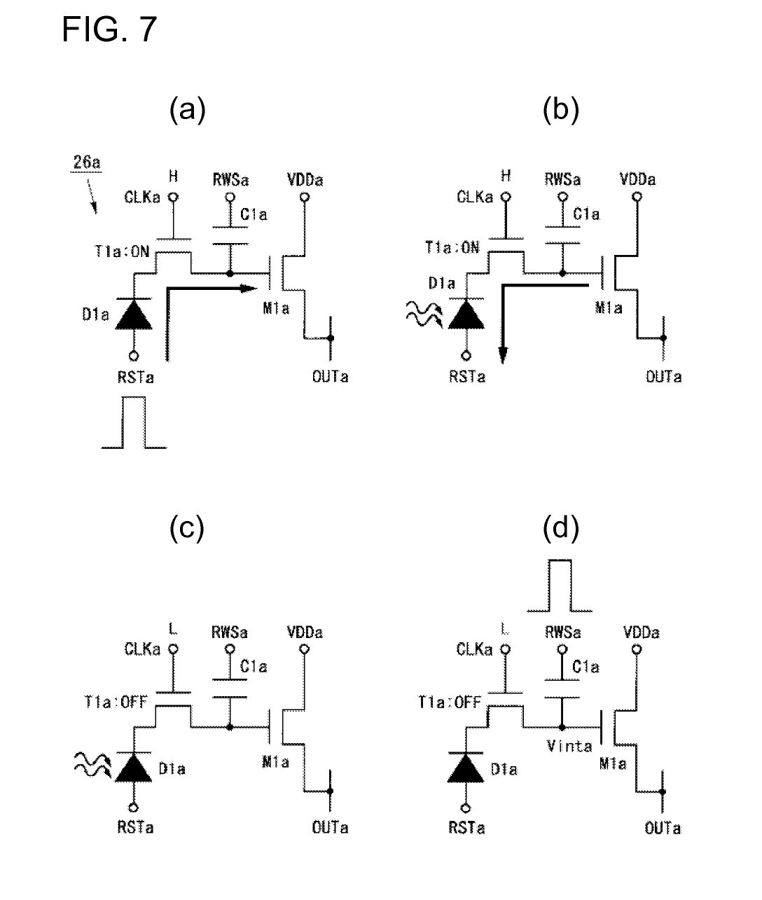

FIG. 7 shows the operations of the first sensor pixel circuit 26a. As shown in FIG. 7, the first sensor pixel circuit 26a performs in a single frame period (a) resetting, (b) building-up, (c) holding, and (d) reading-out. The second sensor pixel circuit 26b operates the same way as the first sensor pixel circuit 26a.

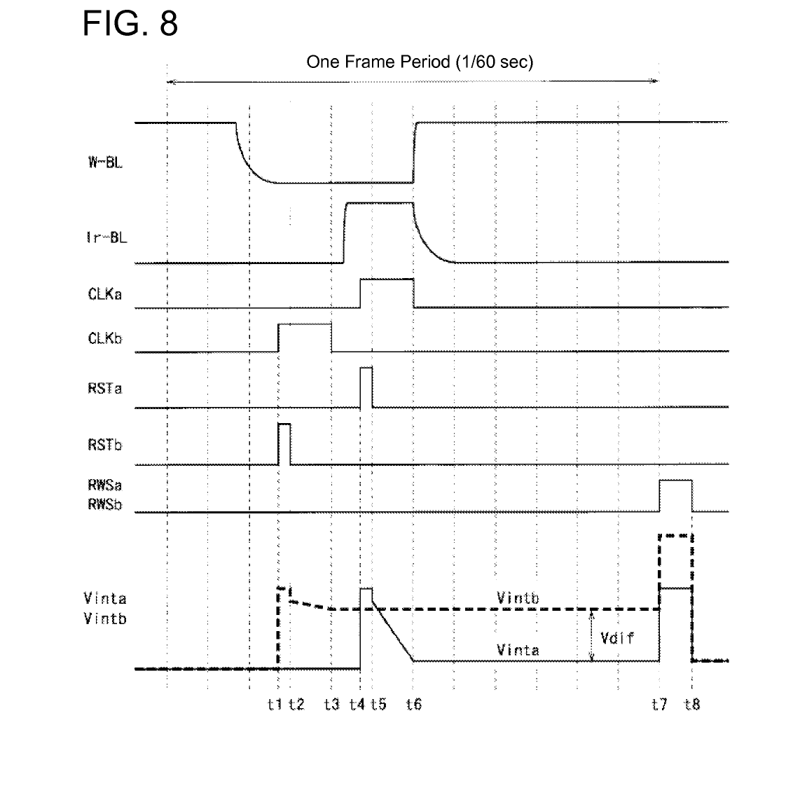

FIG. 8 is a diagram of signal waveforms of the sensor pixel circuit 26. In FIG. 8, W-BL denotes the luminance of the white backlight 31, Ir-BL denotes the luminance of the infrared backlight 32, Vinta denotes the potential of the building-up node of the first sensor pixel circuit 26a, and Vintb denotes the potential of the building-up node of the second sensor pixel circuit 26b. Regarding the first sensor pixel circuit 26a, the resetting period is between time t4 to time t5, the building-up period is from time t5 to time t6, the holding period is from time t6 to time t7, and read-out period is from time t7 to time t8. Regarding the second sensor pixel circuit 26b, the resetting period is from time t1 to time t2, the building-up period is from time t2 to time t3, the holding period is from time t3 to time t7, and the read-out period is from time t7 to t8.

During the resetting period of the first sensor pixel circuit 26a, the clock signal CLKa goes to a high level, the read-out signal RWSa goes to a low level, the reset signal RSTa goes to a high level for resetting. At this time, the transistor T1a is turned ON. As a result, the current flows from the reset line RSTa to the building-up node through the photodiode D1a and the transistor T1a (FIG. 7(a)), and the potential Vinta is reset to a prescribed level.

During the storing period of the first sensor pixel circuit 26a, the clock signal CLKa goes to a high level, and the reset signal RSTa and the read-out signal RWSa go to a low level. At this time, the transistor T1a is turned ON. If light enters the photodiode D1a at this time, the current flows from the building-up node to the reset line RSTa through the transistor T1a and the photodiode D1a, and the electrical charge is removed from the building-up node (FIG. 7(b)). Consequently, the potential Vinta decreases according to the amount of the incoming light while the clock signal CLKa is at a high level.

During the holding period of the first sensor pixel circuit 26a, the clock signal CLKa, the reset signal RSTa, and the read-out signal RWSa go to a low level. At this time, the transistor T1a is turned OFF. If any light enters the photodiode D1a at this time, the potential Vinta does not change, because the transistor T1a is OFF (FIG. 7(c)).

During the read-out period of the first sensor pixel circuit 26a, the clock signal CLKa and the reset signal RSTa go to a low level, the read-out signal RWSa goes to a high level for reading out. At this time, the transistor T1a is turned OFF. The potential Vinta increases by just (Cqa/Cpa) times (Cpa is the capacitance value of the entire first sensor pixel circuit 26a, and Cqa is the capacitance value of the capacitor C1a) the increase in the potential of the read-out signal RWSa. The transistor M1a constitutes a source follower amplifier circuit that uses the transistor (not shown) included in the source driver circuit 23 as a load, and drives the output line OUTa in accordance with the potential Vinta (FIG. 7(d)).

This way, from the first sensor pixel circuit 26a, a sensor signal representing the amount of the light entered while the clock signal CLKa is at a high level (detection period when the infrared backlight 32 is ON) is read out. Similarly, from the second sensor pixel circuit 26b, a sensor signal representing the amount of the light entered while the clock signal CLKb is at a high level (detection period when the infrared backlight 32 is OFF) is read out. By determining the difference between the output signal of the first sensor pixel circuit 26a and the output signal of the second sensor pixel circuit 26b using the differential circuit included in the source driver circuit 23, the difference between the light amount when the infrared backlight 32 is ON and the light amount when the infrared backlight 32 is OFF can be determined, and an inputted image free of external light influence can be obtained.

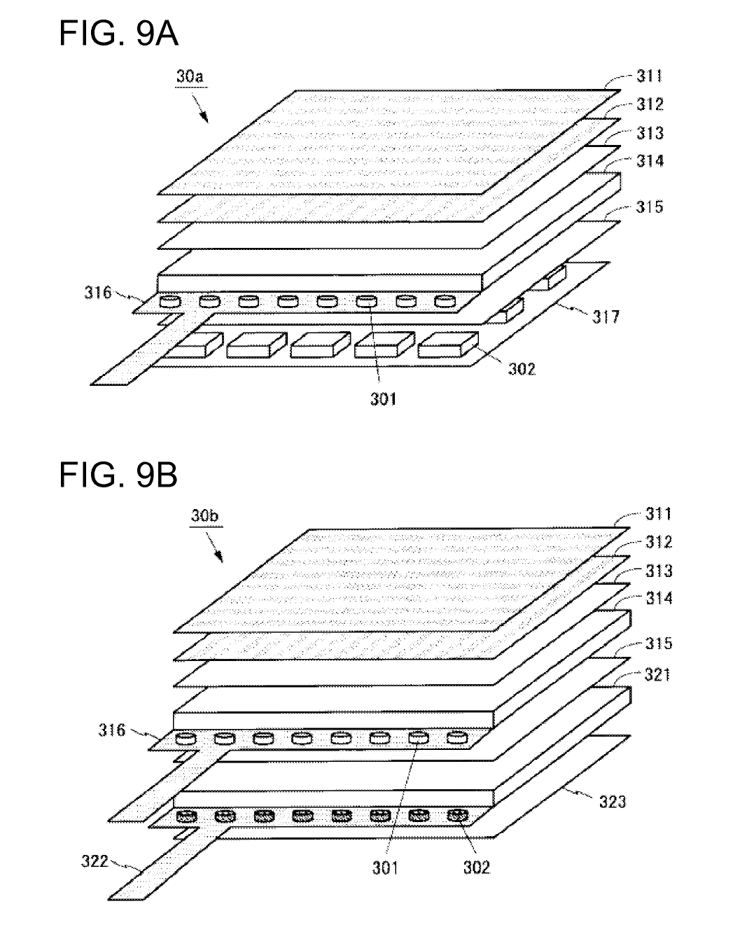

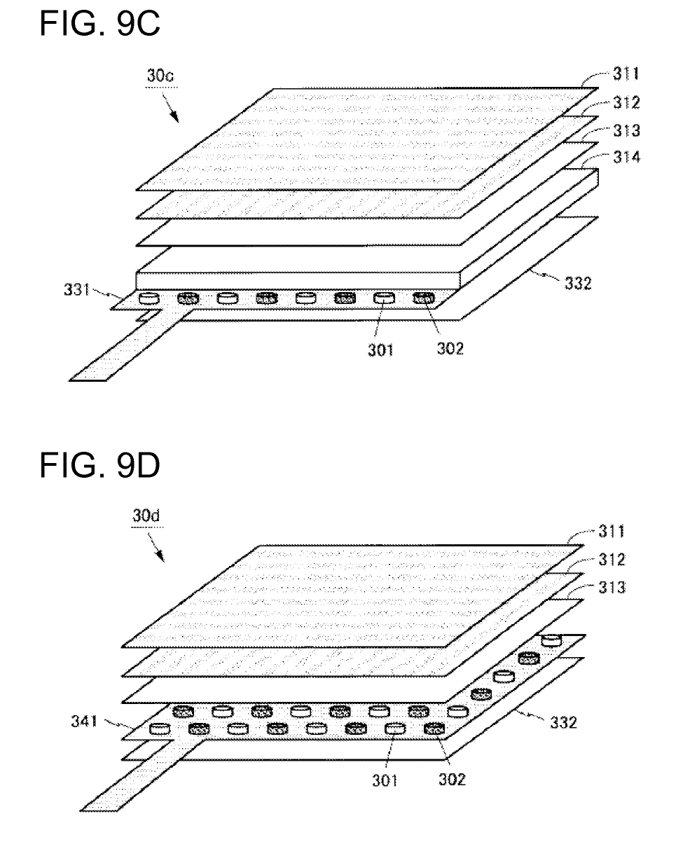

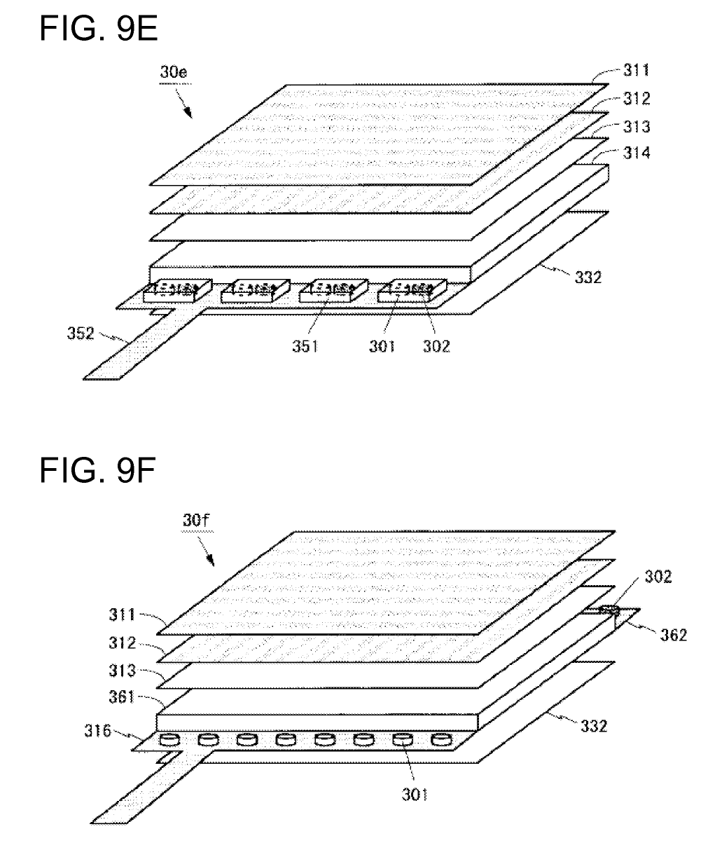

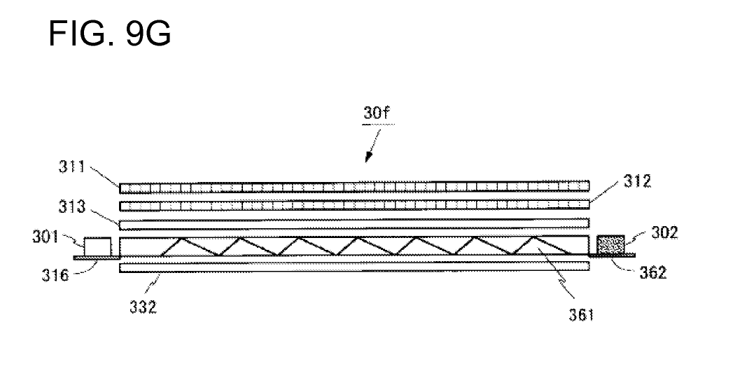

FIG. 9A to FIG. 9F show a configuration example of the backlight 30. Backlights 30a to 30f shown in FIG. 9A to FIG. 9F each includes white LEDs (Light Emitting Diodes) 301 that emit white light and infrared LEDs 302 that emit infrared light. In this embodiment, all the white LEDs 301 are turned ON when the control signal CSb1 is at a high level, and all the infrared LEDs 302 are turned ON when the control signal CSb2 is at a high level.

In the backlight 30a shown in FIG. 9A, on one surface of the light guide plate 314, two lens sheets 311 and 312 and a diffusion sheet 313 are provided, and on the other surface of the light guide plate 314, a reflection sheet 315 is provided. Along a side surface of the light guide plate 314, a flexible printed substrate 316 having white LEDs 301 arranged thereon in a single dimensional manner is provided. On a side of the light guide plate 314 on which the reflection sheet 315 is disposed, a circuit substrate 317 having infrared LEDs 302 arranged thereon in a two dimensional manner is provided. For the reflection sheet 315, a material that transmits infrared light and reflects visible light is used. In the backlight 30b shown in FIG. 9B, on the side of the light guide plate 314 on which the reflection sheet 315 is disposed, a light guide plate 321 and a reflection sheet 323 are provided. Along a side of the light guide plate 321, a flexible printed substrate 322 having infrared LEDs 302 arranged thereon in a single dimensional manner is provided. For the reflection sheet 323, a material that reflects the infrared light is used.

In the backlight 30c shown in FIG. 9C, along a side of the light guide plate 314, a flexible printed substrate 331 having both white LEDs 301 and infrared LEDs 302 arranged thereon in a single dimensional manner is provided. On the side of the light guide plate 314 opposite from the side where the diffusion sheet 313 is provided, a reflection sheet 332 that reflects the visible light and the infrared light is disposed. The backlight 30d shown in FIG. 9D includes a circuit substrate 341 having both the white LEDs 301 and the infrared LEDs 302 arranged thereon in a two dimensional manner. On one side of the circuit substrate 341, two lens sheets 311 and 312, and a diffusion sheet 313 are provided, and on the other side of the circuit substrate 341, a reflection sheet 332 is provided.

In the backlight 30e shown in FIG. 9E, along a side of the light guide plate 314, a flexible printed substrate 352 having resin packages 351 each including both white LEDs 301 and infrared LEDs 302 arranged thereon in a single dimensional manner is provided. In the backlight 30f shown in FIG. 9F, along a side of the light guide plate 361, a flexible printed substrate 316 having white LEDs 301 arranged thereon in a single dimensional manner is provided. Also, along another side of the light guide plate 361 that is opposite from the above-mentioned side, a flexible printed substrate 362 having infrared LEDs 302 arranged thereon in a single dimensional manner is provided. FIG. 9G is a cross-sectional view of the backlight 30f. The light guide plate 361 is processed such that the white light entering through one side surface and the infrared light entering through the opposite side surface both propagate.

As described above, in a liquid crystal display of this embodiment, each frame period includes one period A1 and one period A2, which are set to have the same duration. Also, the sensor pixel circuit 26 includes a first sensor pixel circuit 26a that detects light in period A1 and a second sensor pixel circuit 26b that detects light in period A2. The white backlight 31 is fully turned OFF during periods A1 and A2, and is fully turned ON at other times. The infrared backlight 32 is fully turned ON during period A1, and is fully turned OFF at other times. In the liquid crystal display device of this embodiment, the white backlight 31 is turned OFF for the light sensors 204 conducting the light detection.

The effects of the liquid crystal display device of this embodiment is described below. As shown in FIG. 2, a portion of the light emitted from the backlight 30 enters the light sensor 204 after being reflected by the surfaces of the protective plate 213 (light La and light Lb), the interface between the polarizing plate 212 on the display side and the air (light Lc), or the pixel electrode 203 (light Lx). Visible light included in the lights La to Lc is blocked by the visible light shielding filter 207 or the like, and therefore does not reach the light sensor 204. On the other hand, visible light included in the light Lx is not blocked by the visible light shielding filter 207, and therefore reaches the light sensor 204. Thus, even if the visible light shielding filter 207 is provided, a portion of the backlight light (visible light) for display enters the light sensor 204 as a noise, reducing the effective range (the range of the light amount that can be used) of the light sensor 204 necessary for detecting the touch locations.

For this reason, in a liquid crystal display device of the present embodiment, the white backlight 31 is turned OFF for the light sensor 204 conducting the light detection. Specifically, the entire white backlight 31 is turned OFF during period A1 in which the first sensor pixel circuit 26a detects the light, and during period A2 in which the second sensor pixel circuit 26b detects the light. As a result, the backlight light for display is not reflected inside the liquid crystal panel 20 to enter the light sensor 204 that is detecting the light. Therefore, according to the liquid crystal display device of this embodiment, the effective range of the light sensor 204 can be widened. Consequently, the range of illuminance with which the location of a touch can be detected can be widened.

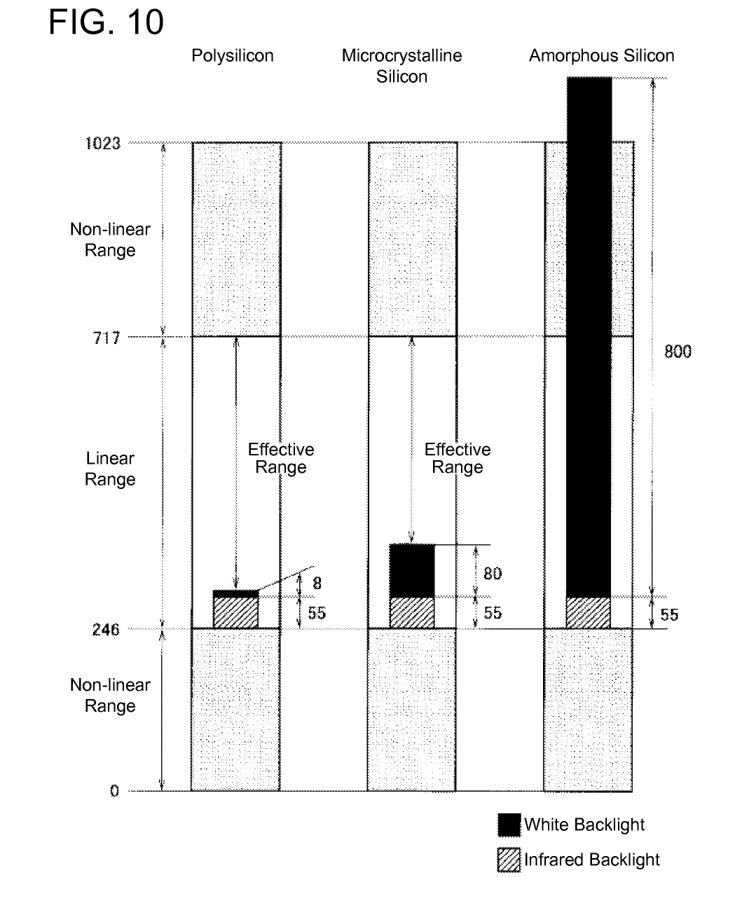

This effect is especially significant if the light sensor is made of amorphous silicon. FIG. 10 shows the effective range of light sensors made of polysilicon, microcrystalline silicon, and amorphous silicon. Light sensors must be used within a linear range, i.e., the range in which the output (detection light amount) varies linearly with the input (incoming light amount). Here, it is assumed that the three kinds of light sensors detect the amount of the light in the same range (gradations 0 to 1023), have an equal linear range (gradation 246 to 717), and have the same sensitivity to infrared light.

In the following description, any external light entering the light sensors after being reflected by the backlight is ignored. When the white backlight and the infrared backlight are both ON, the effective range of the light sensors can be obtained by subtracting the reflected white backlight light amount and the reflected infrared backlight light amount from the linear range of the light sensor. Here, it is assumed that regarding a light sensor made of polysilicon, the reflected white backlight light amount corresponds to 8 gradations, and the reflected infrared backlight light amount corresponds to 55 gradations. In this case, the light sensors made of polysilicon have an effective range of 408 gradations (=717−246−55−8).

The sensitivity to visual light of light sensors made of microcrystalline silicon is about 10 times higher than that of the light sensors made of polysilicon. Consequently, regarding a light sensor made of microcrystalline silicon, the reflected white backlight light amount corresponds to 80 gradations. Therefore, the light sensor made of microcrystalline silicon has an effective range of 336 gradations (=717−246−55−80).

The sensitivity to visual light of light sensors made of amorphous silicon is about 100 times higher than that of the light sensors made of polysilicon. Therefore, regarding a light sensor made of amorphous silicon, the reflected white backlight light amount corresponds to 800 gradations. By subtracting the reflected white backlight light amount and the reflected infrared backlight light amount from the linear range of the light sensor, a negative value is obtained. This means that the light sensor made of amorphous silicon does not have an effective range.

Thus, in the case of a light sensor made of amorphous silicon, if white backlight light is reflected inside the liquid crystal panel and enters the light sensor by even a very small amount, output of the light sensor becomes saturated. Therefore, for conventional liquid crystal display devices, it is extremely difficult to employ light sensors made of amorphous silicon if infrared light is used for detecting touch locations.

In contrast, in a liquid crystal display device of the present embodiment, because a white backlight 31 is turned OFF for a light sensor 204 when the light sensor is conducting the light detection, visible light emitted from the white backlight 31 does not enter the light sensor 204 when the light sensor is conducting the light detection. Consequently, even if the light sensor 204 is made of amorphous silicon, the effective range of the light sensor 204 can be secured, and the illuminance range in which touch locations can be detected can be widened.

Next, external light that enters the light sensor after being reflected by the backlight is considered. In this case, to obtain the effective range of the light sensor, the reflected external light amount must also be subtracted. For example, if the transmittance of the liquid crystal panel is 10%, reflection ratio of the backlight light is 50%, and the external light illuminance is 100 thousand lux, the illuminance of external light reflected by the backlight is 5000 lux. If the illuminance of the white backlight is 16000 lux, in the case of the light sensor made of polysilicon, the amount of the external light reflected by the backlight corresponds to 2.5 gradations (=8×5000/16000). In the case of the light sensor made of microcrystalline silicon, this light amount corresponds to 25 gradations, and this light amount of the light sensor made of amorphous silicon corresponds to 250 gradations. Therefore, in the case of the light sensor made of amorphous silicon, the effective range of the light sensor can still be secured even if the external light reflected by the backlight is considered.

As described above, in a liquid crystal display device of this embodiment, the white backlight is turned OFF for the light sensor conducting the light detection, so that visible light emitted from the white backlight is prevented from entering the light sensor conducting the light detection. As a result, the effective range of the light sensor can be widened. Also, by detecting the light amount when the infrared backlight is ON and the light amount when the infrared backlight is OFF, the difference between the two can be determined, and an inputted image free of external light influence can be obtained. Also, by using the white backlight that is fully turned ON and OFF and the infrared backlight that is fully turned ON and OFF, backlights can easily be configured. Also, because the white backlight is fully turned OFF during a prescribed period in each frame, motion picture display quality can be improved in a manner similar to the case where a black image is inserted.

### Embodiment 2

A liquid crystal display device of Embodiment 2 of the present invention has the same configuration as the liquid crystal display device of Embodiment 1 and operates in a similar manner (see FIG. 1 to FIG. 8). The liquid crystal display device of this embodiment differs from the liquid crystal display device of Embodiment 1 in that of two kinds of backlights, at least one of them is partially turned ON and OFF, whereas in Embodiment 1, the two kinds of backlights are fully turned ON and OFF. The difference between this embodiment and Embodiment 1 is described below.

The backlight 30 of this embodiment is configured to include: a white backlight 31 that is fully turned ON and OFF and an infrared backlight 32 that can partially be turned ON (type A); a white backlight 31 that can partially be turned OFF and an infrared backlight 32 that is fully turned ON and OFF (type B); or a white backlight 31 that can partially be turned OFF and an infrared backlight 32 that can partially be turned ON (type C).

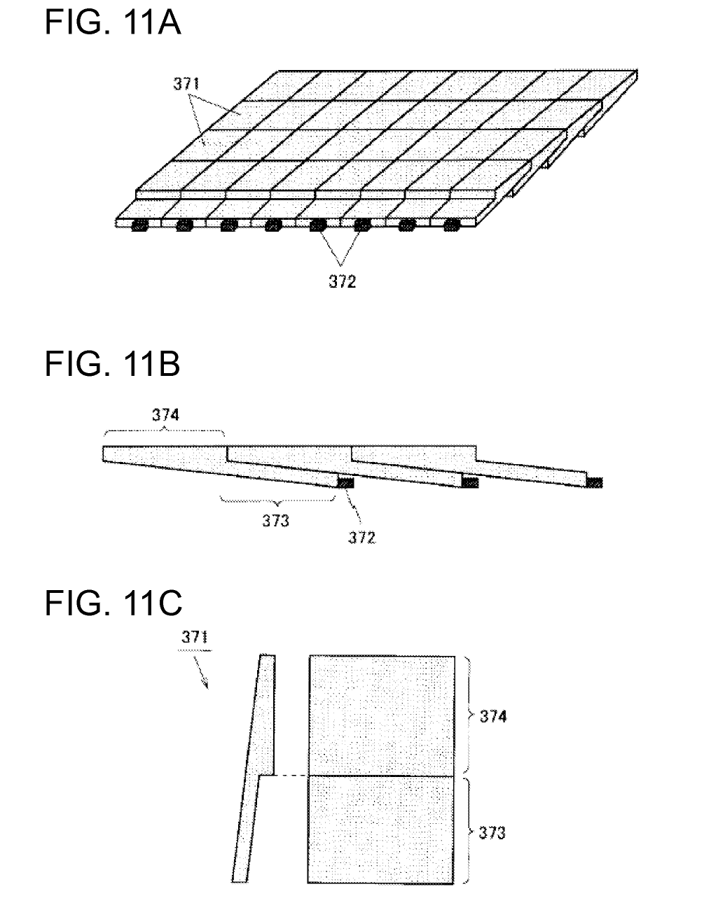

A known backlight that can partially be turned ON and OFF is the backlight with a tandem structure shown in FIG. 11A to FIG. 11C. The backlight of the tandem structure has a plurality of tandem type light guide plates 371 arranged in a two dimensional manner, where an LED 372 is provided for each of the tandem type light guide plates 371 (FIG. 11A and FIG. 11B). The tandem type light guide plates 371 each includes a light guide section 373 and a light emitting section 374 (FIG. 11C). The tandem type light guide plates 371 are arranged such that the light emitting sections 374 form a flat surface. LEDs 372 are disposed at the edge of the light guide sections 373.

As the backlight 30, any of backlights 30a to 30f shown in FIG. 9A to FIG. 9F or a modified version of any of them is used. As the A type backlight 30, a backlight 30a, for example, is used. Alternatively, a backlight 30b including a tandem type version of the infrared backlight 32 may be used. As the B type backlight 30, the backlight 30a or 30b including a tandem type version of the white backlight 31, for example, is used. Alternatively, a backlight 30a in which the white LEDs 301 and the infrared LEDs 302 are arranged in reverse pattern may be used. In the latter case, a reflection sheet 315 that transmits visible light and blocks infrared light is used. As the C type backlight 30, a backlight 30d, for example, is used. Alternatively, a backlight 30a including a tandem type version of the white backlight 31, or a backlight 30b, 30c, 30e, or 30f each including a tandem type version of the two types of backlights may be used.

If a white backlight 31 that can partially be turned OFF is used, the display control circuit 10 outputs a plurality of control signals CSb1, and each control signal CSb1 is assigned to one or more white LEDs 301. The white backlight 31 is partially turned OFF in accordance with the plurality of control signals CSb1. If an infrared backlight 32 that can partially be turned ON is used, the display control circuit 10 outputs a plurality of control signals CSb2, and each control signal CSb2 is assigned to one or more infrared LEDs 302. The infrared backlight 32 is partially turned ON in accordance with the plurality of control signals CSb2.

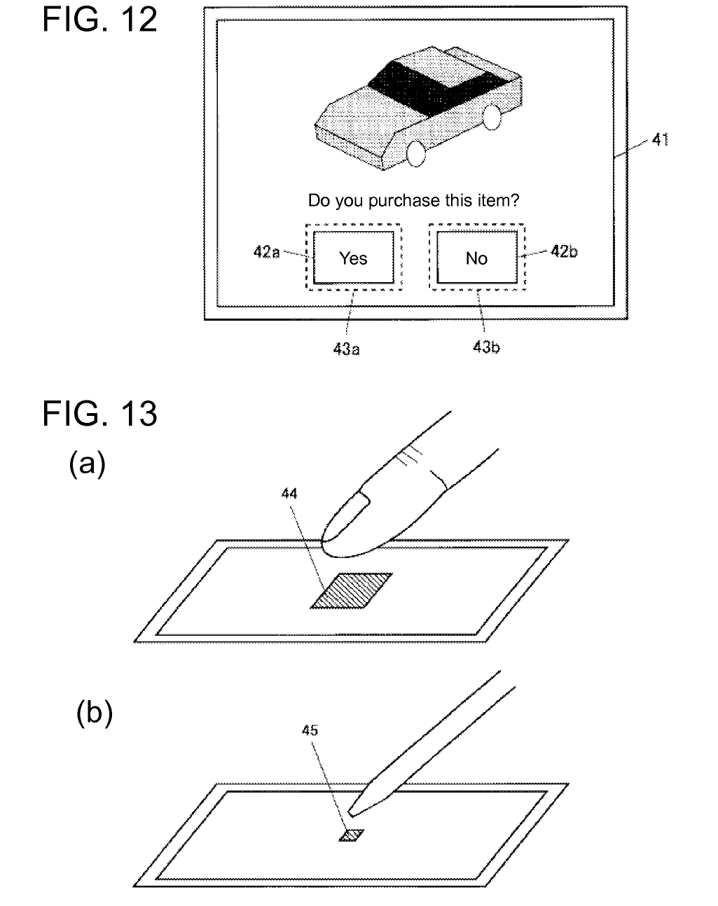

FIG. 12 shows an example display screen of the liquid crystal display device of this embodiment. On the display screen 41 shown in FIG. 12, an image of a car and two buttons 42a and 42b are displayed. In this case, there is no need to detect the touch location over the entire display screen 41. The touch location only needs to be detected near the buttons 42a and 42b. Therefore, for the display screen 41, detection regions 43a and 43b are set near the buttons 42a and 42b. The locations of the detection regions 43a and 43b change depending on the display content. Alternatively, the location of the detection region may be fixed regardless of the display contents.

In this embodiment, as in Embodiment 1, the white backlight 31 is turned OFF during period A1 (the light detection period of the first sensor pixel circuit 26a) and period A2 (the light detection period of the second sensor pixel circuit 26b), and is turned ON at other times. The infrared backlight 32 is turned ON during period A1, and is turned OFF at other times. However, if the white backlight 31 can partially be turned OFF, the white backlight 31 is partially turned OFF during periods A1 and A2 for the detection region. If the infrared backlight 32 can partially be turned ON, the infrared backlight 32 is partially turned ON during period A1 for the detection region. For example, when the display screen 41 shown in FIG. 12 is displayed, the white backlight 31 that can partially be turned OFF is turned OFF for the detection regions 43a and 43b, and the infrared backlight 32 that can partially be turned ON is turned ON for the detection regions 43a and 43b.

As described above, the liquid crystal display device of this embodiment includes a white backlight 31 that is partially turned OFF during periods A1 and A2 for the detection region set on the display screen, or an infrared backlight 32 that is partially turned ON during period A1 for the detection region set on the display screen, or includes both of such the white backlight 31 and the infrared backlight 32. Because the white backlight 31 is partially turned OFF for the detection region and the remaining region stays irradiated by the white backlight 31, any influence on the display can be reduced. Because the infrared backlight 32 is partially turned ON to irradiate only the detection region, the power consumption of the infrared backlight 32 can be reduced.

An application example of the liquid crystal display device of this embodiment is described below. A first application example is a method in which the size of the detection region is switched according to the size of the detection object (a finger, a pen, or the like) (see FIG. 13). Depending on the form of application of the liquid crystal display device, for example, sometimes the size of the detection object in the inputted image obtained using the light sensors is known. For example, when the size of a finger and the size of a pen in the inputted image are known to be (30×30) pixels and (8×8) pixels, respectively, a finger is detected in the following manner. A detection region 44, which is as large as the area of (30×30) sensor pixel circuits, is set, the white backlight 31 is partially turned OFF for the detection region 44, and the infrared backlight 32 is partially turned ON for the detection region 44 (FIG. 13(a)). When a pen is to be detected, a detection region 45 having the same size as the area of (8×8) sensor pixel circuits is set, the white backlight 31 is partially turned OFF for the detection region 45, and the infrared backlight 32 is partially turned ON for the detection region 45 (FIG. 13(b)). Thus, by switching the size of the detection region depending on the detection object, any influence on the display and the power consumption of the infrared backlight can be reduced in a manner suitable for the detection object.

A second application example is a method in which a detection region is set when the detection object approaches the liquid crystal panel (see FIG. 14). In the initial state, the white backlight 31 is fully turned OFF for a prescribed period and the infrared backlight 32 is fully turned ON for a prescribed period so that a touch location can be detected over the entire display screen 46 (FIG. 14(a)). In this state, the inputted image is processed, and when an approaching detection object is detected, a detection region 47 is set on the display screen 46 according to the size and the location of the detection object (FIG. 14(b)). The white backlight 31 is partially turned OFF for the detection region 47 and the infrared backlight 32 is partially turned ON for the detection region 47, so that the touch location is detected within the detection region 47. Thus, by setting a detection region when the detection object approaches the liquid crystal panel, any influence on the display and the power consumption of the infrared backlight can suitably be reduced according to the distance between the detection object and the liquid crystal panel.

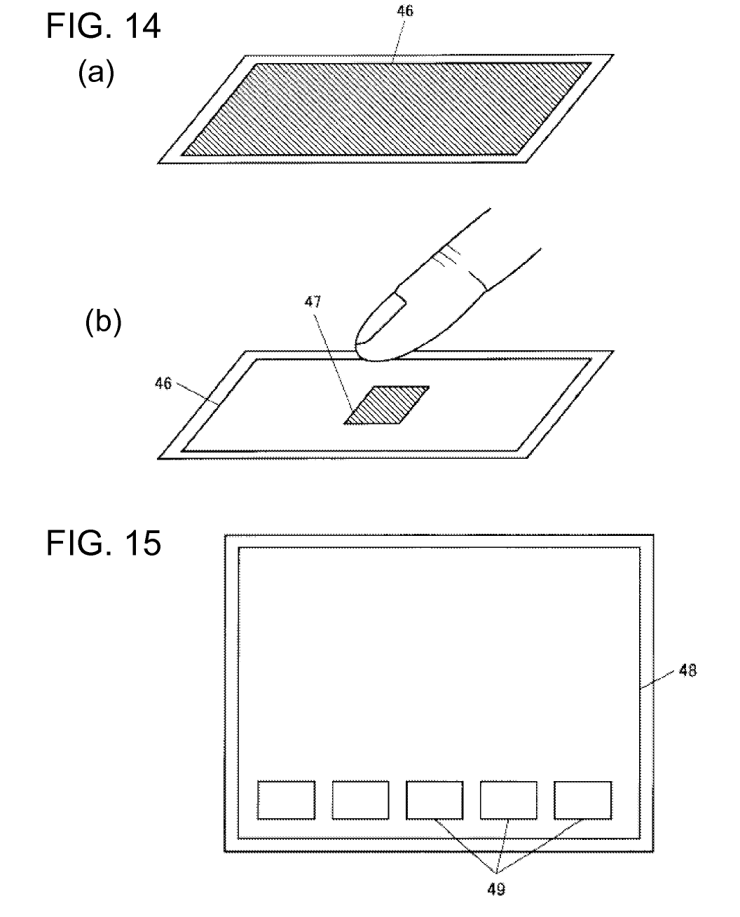

A third application example is a method in which the backlight is controlled to reduce the power consumption of the backlight (see FIG. 15). On the display screen 48 shown in FIG. 15, five buttons 49 for launcher are displayed. When a finger touches any of the buttons 49, the software linked to the touched button is launched. Here, the images other than buttons 49 are shown in some cases, and only buttons 49 are shown in other cases. In the former case, the white backlight 31 is fully turned OFF during the light detection period and is fully turned OFF at other times, and the infrared backlight 32 is partially turned ON for the region around the buttons 49 during the light detection period and is fully turned OFF at other times. In the latter case, the white backlight 31 is partially turned on for the region around the buttons 49 during the time other than the light detection period. This way, the power consumption of the backlight can be reduced.

### Embodiment 3

A liquid crystal display device of Embodiment 3 of the present invention has the same configuration as the liquid crystal display device of Embodiment 1 (see FIG. 1). The liquid crystal display device of Embodiment 1 uses two kinds of sensor pixel circuits 26 to detect the light amount when the infrared backlight 32 is ON and the light amount when the infrared backlight 32 is OFF. In contrast, a liquid crystal display device of this embodiment uses one kind of sensor pixel circuits 26 to detect the light amount when the infrared backlight 32 is ON. The difference between this embodiment and Embodiment 1 is described below.

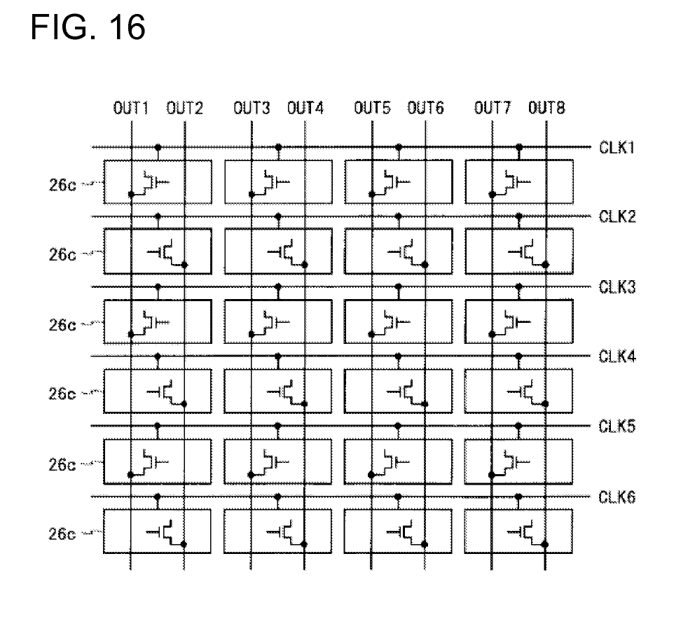

FIG. 16 shows the sensor pixel circuits 26 arranged in the pixel region 21. In the pixel region 21 of this embodiment, (n×m/2) sensor pixel circuits 26c are disposed. As shown in FIG. 16, (n×m/2) sensor pixel circuits 26c are disposed near the intersections of odd-numbered clock lines CLK1 to CLKn-1 and the odd-numbered output lines OUT1 to OUTm−1, and also near the intersections of even-numbered clock lines CLK2 to CLKn and even-numbered output lines OUT2 to OUTm.

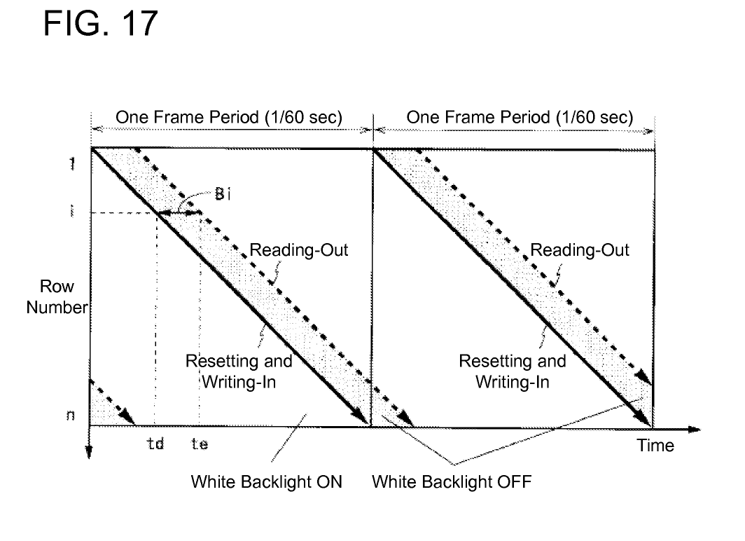

FIG. 17 shows the timing of writing-in for the display pixel circuit 25, the timing of turning ON and OFF of the white backlight 31, and the timing of resetting and reading-out for the sensor pixel circuit 26c. As shown in FIG. 17, the sensor pixel circuits 26c are reset once per frame period, in the sequential order of the lines. More specifically, at the beginning of a frame period, sensor pixel circuits 26c in row 1 are reset first, sensor pixel circuits 26c in row 2 are reset next, and after that, sensor pixel circuits 26c in row 3 are reset.

Reading out from the sensor pixel circuits 26c in row i (i is an integer of at least 1 and no greater than n) is conducted when a prescribed time has passed after the sensor pixel circuits 26c in row i are reset. For each of sensor pixel circuits 26c, the time between resetting and reading-out is the light detection period. For example, in FIG. 17, the sensor pixel circuits 26c of row i are reset at time td, and reading out from the sensor pixel circuits 26c in row i is conducted at time te. The sensor pixel circuits 26c in row i detect light during period Bi, from time td to time te.

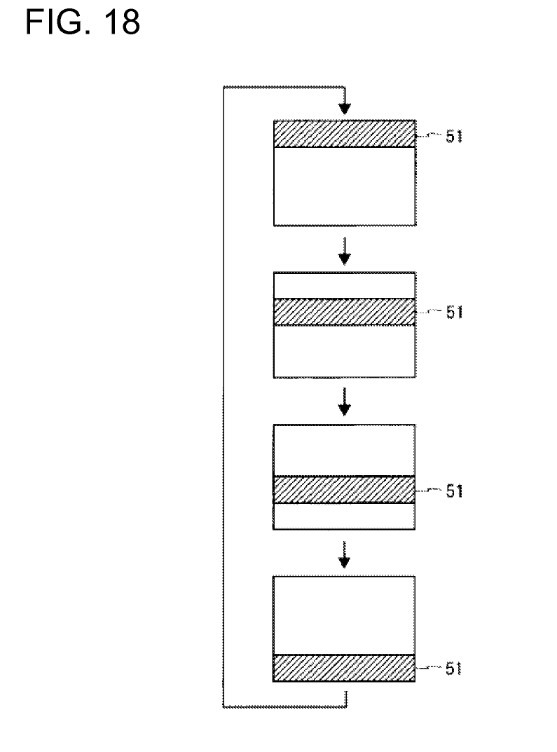

FIG. 18 shows the light detection region of the light sensor 204. The sensor pixel circuit 26c is subjected to resetting and reading out at timings described above. As a result, the light detection region of the light sensors 204 becomes a band-shaped region 51 shown in FIG. 18. The band-shaped region 51 moves downward in the display screen.

The white backlight 31 is partially turned OFF for the band-shaped region 51 shown in FIG. 18. The white backlight 31 can be configured, for example, in the same manner as in Embodiment 2. Alternatively, a plurality of cold-cathode tubes may be arranged and be turned OFF sequentially. The infrared backlight 32 is always fully turned ON. As shown in FIG. 17, display pixel circuits 25 subjected to writing-in are those for which the white backlight 31 has just turned OFF.

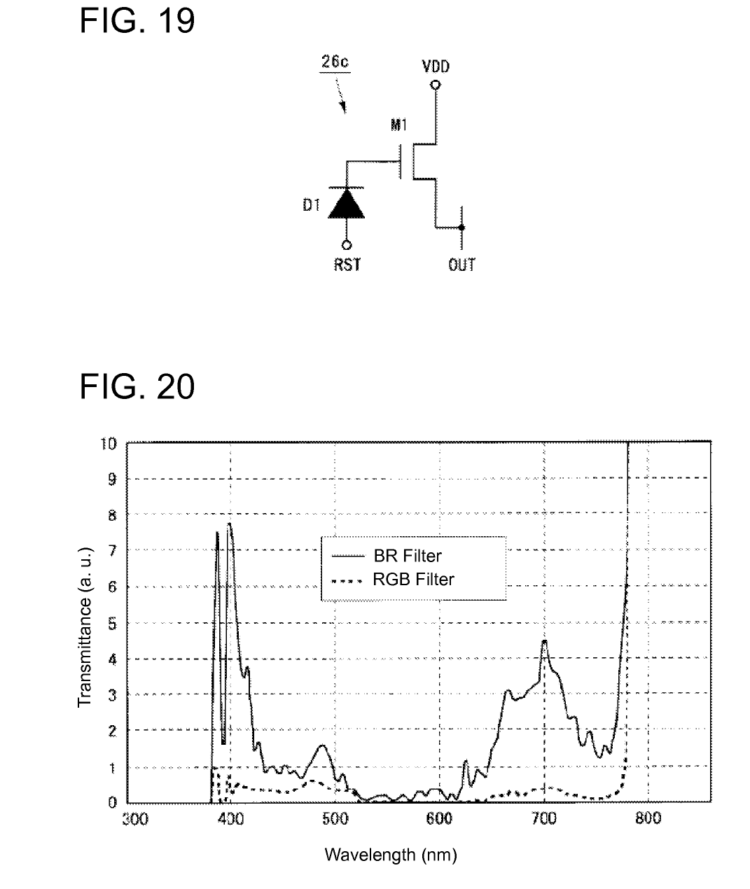

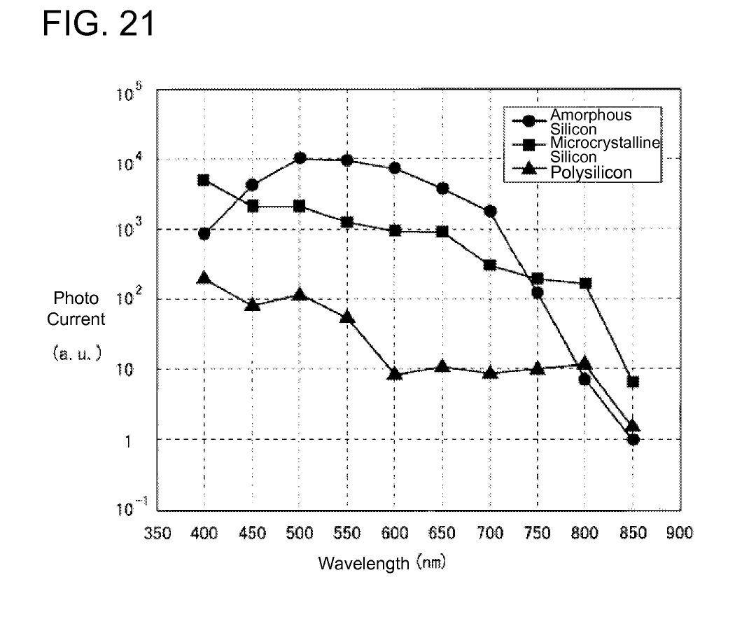

FIG. 19 is a circuit diagram of the sensor pixel circuit 26c. As shown in FIG. 19, in the sensor pixel circuit 26c, the anode of the photodiode D1 is connected to the reset line RST, and the cathode is connected to the gate of the transistor M1. The drain of the transistor M1 is connected to the power supply line VDD, and the source is connected to the output line OUT. In the sensor pixel circuit 26c, the node connected to the gate of the transistor M1 serves as the building-up node that builds up the charge representing the detected light amount. The photodiode D1 functions as the light sensor 204. Because the sensor pixel circuit 26c is not connected to the read-out line, there is no need to provide read-out lines to the liquid crystal panel 20 of this embodiment.

As described above, in the liquid crystal display device of the present embodiment, the white backlight 31 is partially turned OFF for the band-shaped region 51 moving in a prescribed direction in the display screen, and light sensors 204 corresponding to the band-shaped region 51 detect light. Thus, also in this embodiment, the white backlight 31 is turned OFF for light sensors detecting light. Therefore, in this embodiment, as in Embodiment 1, visible light emitted from the white backlight is prevented from entering the light sensors conducting the light detection. As a result, the effective range of the light sensor can be widened.

In the description above, the infrared backlight 32 is always fully turned ON. Thus, the infrared backlight 32 can easily be configured. Alternatively, the infrared backlight 32 may partially be turned ON for the band-shaped region 51. Thus, the power consumption of the infrared backlight 32 can be reduced. Also, Embodiment 2 may be applied to this embodiment, such that the white backlight is partially turned OFF for the detection region set in the display region, and the infrared backlight is partially turned ON for the detection region set in the display region.

Various modification examples of the liquid crystal display device according to the embodiments of the present invention can be configured. For example, any number of the sensor pixel circuits 26 may be disposed in the pixel region 21. Also, as the visible light shielding filter 207, instead of the BR filter formed by layering a red color filter and a blue color filter for display, an RGB filter formed by layering a red color filter, a green color, and a blue color filter for display may be used. FIG. 20 shows the spectral characteristics of the BR filter and of the RGB filter. With the RGB filter, more visible light can be blocked from entering the light sensors.

The light sensor may be made of polysilicon, microcrystalline silicon, amorphous silicon, or the like. These materials have different crystallinity, and therefore light sensors made of different materials have different sensitivity characteristics. Light sensors made of polysilicon have a wide linear range, and therefore can be used for applications requiring a wide effective range (mobile applications, for example). Light sensors made of microcrystalline silicon have a relatively high sensitivity and a relatively wide linear range, and therefore can be used for various applications. Light sensors made of amorphous silicon have a high sensitivity, and therefore can be used for applications requiring a high sensitivity.

### INDUSTRIAL APPLICABILITY

The display device equipped with light sensors of the present invention has a wide light sensor effective range, and therefore can be used for a wide variety of display devices such as liquid crystal display devices equipped with light sensors.

### DESCRIPTION OF REFERENCE CHARACTERS

10 display control circuit
20 liquid crystal panel
21 pixel region
22 gate driver circuit
23 source driver circuit
24 sensor row driver circuit
25 display pixel circuit
26 sensor pixel circuit
30 backlight
31 white backlight
32 infrared backlight
43, 44, 45, 47 detection region
51 band-shaped region
204 light sensor
207 visible light shielding filter

1. A display device equipped with a plurality of light sensors, comprising:
a display panel having a plurality of light sensors arranged thereon in a two dimensional manner;
a first light source that emits visible light;
a second light source that emits infrared light; and
a filter disposed in a path of light entering said light sensors to transmit infrared light and blocks visible light,
wherein said first light source is turned OFF for light sensors conducting light detection.

2. The display device according to claim 1,
wherein said light sensors include light sensors that detect light during a first detection period and light sensors that detect light during a second detection period,
wherein said first light source is turned OFF during said first and second detection periods for a region that includes the light sensors conducting the light detection, and
wherein said second light source is turned ON during said first detection period for the region that includes the light sensors conducting the light detection, and is fully turned OFF during said second detection period.

3. The display device according to claim 2, wherein each frame period includes one said first detection period and one said second detection period, each of them being set to have an equal duration.

4. The display device according to claim 2, wherein said first light source is fully turned OFF during said first and second detection periods.

5. The display device according to claim 2, wherein said second light source is fully turned ON during said first detection period.

6. The display device according to claim 2, wherein said first light source is partially turned OFF during said first and second detection periods for a detection region set on a display screen.

7. The display device according to claim 2, wherein said second light source is partially turned ON during said first detection period for the detection region set on the display screen.

8. The display device according to claim 6, wherein said detection region has a size in accordance with a detection object.

9. The display device according to claim 6, wherein said detection region is set when the detection object approaches the display panel.

10. The display device according to claim 1, wherein said first light source is partially turned OFF for a band-shaped region moving in a display screen in a prescribed direction, and
wherein light sensors corresponding to said band-shaped region conduct light detection.

11. The display device according to claim 10, wherein said second light source is fully turned ON.

12. The display device according to claim 10, wherein said second light source is partially turned ON for said band-shaped region.

13. The display device according to claim 1, wherein said light sensors are made of amorphous silicon.

14. The display device according to claim 1, wherein said light sensors are made of microcrystalline silicon.

15. The display device according to claim 1, wherein said light sensors are made of polysilicon.
